(19) United States
(12) Patent Application Publication
(10) Pub. No.: US 2026/0161367 A1
(43) Pub. Date: Jun. 11, 2026

(54) DEVELOPMENT ENVIRONMENT DEVICE, DEVICE CONTROL METHOD, AND NON-TRANSITORY COMPUTER-READABLE STORAGE MEDIUM

(71) Applicant: Panasonic Automotive Systems Co., Ltd., Kanagawa (JP)

(72) Inventors: Masataka YAMAMOTO, Kanagawa (JP); Yosuke ISHIKAWA, Kanagawa (JP); Tomoya OSAKI, Kanagawa (JP)

(73) Assignee: Panasonic Automotive Systems Co., Ltd., Kanagawa (JP)

(21) Appl. No.: 19/409,320

(22) Filed: Dec. 4, 2025

(30) Foreign Application Priority Data
Dec. 6, 2024 (JP) 2024-213790

(51) Int. Cl. G06F 8/33; G06F 8/41; G06F 9/455

(52) U.S. Cl. CPC G06F 8/33; G06F 8/43; G06F 9/455; G06F 2009/45595

(57) ABSTRACT

A development environment device includes a memory in which a program is stored, and a processor coupled to the memory and configured to perform processing by executing the program. The processing includes determining whether a first waiting period is equal to or longer than a predetermined first period, the first waiting period being a period from transmission of a change instruction for a reception frequency of the tuner to the device environment until reception of a change completion response to the change instruction from the device environment, when the first waiting period is shorter than the first period, sequentially performing transmission and reception with the device environment for a plurality of checks, and when the first waiting period is equal to or longer than the first period, omitting transmission and reception during the plurality of checks, and performing transmission and reception with the device environment for a last check.

### CROSS-REFERENCE TO RELATED APPLICATIONS

This application is based on and claims priority under 35 USC 119 from Japanese Patent Application No. 2024-213790 filed on Dec. 6, 2024, the entire content of which is incorporated herein by reference.

### TECHNICAL FIELD

The present disclosure relates to a development environment device, a device control method, and a non-transitory computer-readable storage medium.

### BACKGROUND ART

In the related art, device development has been carried out using a virtual environment. By emulating a device implemented by hardware as software and incorporating the device into a development environment as a virtual device, it is possible to verify the operation of the device without the need for physical hardware.

In addition, device development is being carried out using a development environment in which a virtual device and a device implemented by hardware, that is, a physical device, coexist. For example, JP7554022B2 discloses a development environment creation system that creates a development environment for software that controls a target device implemented by hardware. In JP7554022B2, a local environment in which a physical device is disposed and a cloud environment including a development environment creation system are communicably connected, and data is exchanged between the cloud environment and the local environment.

### SUMMARY

The present disclosure has been made in view of the above circumstances, and an object of the present disclosure is to improve the efficiency of device development in a virtual environment capable of data communication with a device in a physical environment.

A development environment device connected via a predetermined communication network to a device environment that includes a target device having a tuner, the development environment device includes a memory in which a program is stored, and a processor coupled to the memory and configured to perform processing by executing the program. The processing includes determining whether a first waiting period is equal to or longer than a predetermined first period, the first waiting period being a period from transmission of a change instruction for a reception frequency of the tuner to the device environment until reception of a change completion response to the change instruction from the device environment, when the first waiting period is shorter than the first period, sequentially performing transmission and reception with the device environment for a plurality of checks performed when the reception frequency of the tuner is changed, and when the first waiting period is equal to or longer than the first period, omitting transmission and reception during the plurality of checks, and performing transmission and reception with the device environment for a last check.

A device control method to be executed by a development environment device connected via a predetermined communication network to a device environment that includes a target device having a tuner, the device control method includes determining whether a first waiting period is equal to or longer than a predetermined first period, the first waiting period being a period from transmission of a change instruction for a reception frequency of the tuner to the device environment until reception of a change completion response to the change instruction from the device environment, when the first waiting period is shorter than the first period, sequentially performing transmission and reception for a plurality of checks performed when changing the reception frequency of the tuner with the device environment, and when the first waiting period is equal to or longer than the first period, omitting transmission and reception during the plurality of checks, and performing transmission and reception for a last check with the device environment.

A non-transitory computer-readable storage medium has a computer program stored thereon and readable by a computer of a development environment device, the development environment device being connected via a predetermined communication network to a device environment that includes a target device having a tuner. The computer program, when executed by the computer, causes the development environment device to perform determining whether a first waiting period is equal to or longer than a predetermined first period, the first waiting period being a period from transmission of a change instruction for a reception frequency of the tuner to the device environment until reception of a change completion response to the change instruction from the device environment, when the first waiting period is shorter than the first period, sequentially performing transmission and reception with the device environment for a plurality of checks performed when the reception frequency of the tuner is changed, and when the first waiting period is equal to or longer than the first period, omitting transmission and reception during the plurality of checks, and performing transmission and reception with the device environment for a last check.

Any combination of the above components, and conversion of an expression of the present disclosure between a method, a device, a system, a storage medium, a computer program, and the like are also effective in an aspect of the present disclosure.

According to the present disclosure, it is possible to improve the efficiency of device development in a virtual environment capable of data communication with a device in a physical environment.

### BRIEF DESCRIPTION OF DRAWINGS

FIG. 1 is a block diagram illustrating an example of the configuration of a device development system according to a first embodiment;

FIG. 2 is a flowchart illustrating a first example of a transfer rate reduction process according to the first embodiment;

FIG. 3 is a schematic diagram illustrating the role of a tuner that performs a back search according to the first embodiment;

FIG. 4 is a flowchart illustrating a second example of the transfer rate reduction process according to the first embodiment;

FIG. 5 is a schematic diagram illustrating an example of a transfer rate reduction method according to the first embodiment;

FIG. 6 is a block diagram illustrating an example of the configuration of a device development system according to a second embodiment;

FIG. 7 is a sequence diagram of a Seek process in the related art;

FIG. 8 is a flowchart illustrating a first example of a Seek process according to the second embodiment;

FIG. 9 is a flowchart illustrating a second example of the Seek process according to the second embodiment; and

FIG. 10 is a flowchart illustrating a third example of the Seek process according to the second embodiment.

### DESCRIPTION OF EMBODIMENTS

### Background of Present Disclosure

As in JP7554022B2, when data is exchanged between a physical environment in which a physical device is disposed and a virtual environment for device development, data loss may occur due to a limitation on a data transfer rate. In addition, if a delay occurs during data transfer, device development may take time. That is, the development environment creation system of JP7554022B2 leaves room for improvement in the efficiency of device development using a virtual environment, for example, in terms of time and cost.

Therefore, an object of the following embodiments is to improve the efficiency of device development in a virtual environment that is capable of data communication with a device in a physical environment.

Hereinafter, embodiments in which a development environment device, a device control method, and a program according to the present disclosure are specifically disclosed will be described in detail with reference to the drawings as appropriate. However, unnecessarily detailed description may be omitted. For example, the detailed description of already well-known matters and the repeated description of substantially the same configuration may be omitted. This is to avoid unnecessary redundancy of the following description and to facilitate understanding of a person skilled in the art. The accompanying drawings and the following description are provided for those skilled in the art to fully understand the present disclosure, and are not intended to limit subject matters described in the claims. Further, in the present specification, the terms “first” and “second” are used merely to distinguish components and the like for convenience of description, and are not intended to be interpreted as being limited to specific components and the like.

### First Embodiment

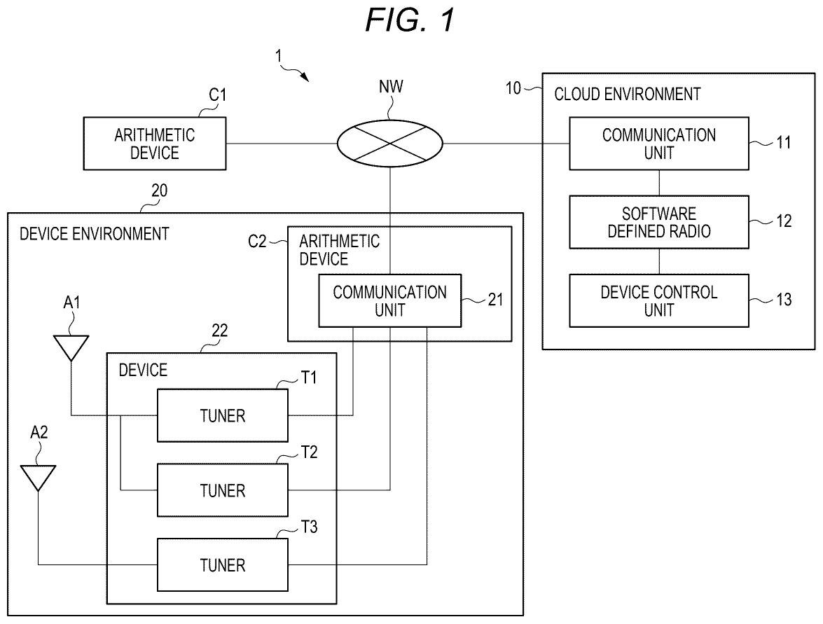

FIG. 1 is a block diagram illustrating an example of the configuration of a device development system 1 according to a first embodiment. The device development system 1 according to the present embodiment is a system that allows a user such as a device developer to perform device development by using a virtual environment connected to a device provided in a physical environment via a communication network.

The device development system 1 includes an arithmetic device C1, a cloud environment 10, and a device environment 20. Each unit included in the device development system 1 is connected by a network NW.

The arithmetic device C1 is implemented using a general-purpose computer device such as a personal computer or a server computer. The cloud environment 10 is a virtual environment that is available via the network NW. A user can perform device development by operating the arithmetic device C1 and using various resources (to be described later) of the cloud environment 10 via the network NW.

The arithmetic device C1 may include a control unit, a storage unit, a communication circuit, an input-output unit, and the like, all of which are not illustrated. The control unit (not illustrated) may be implemented by using, for example, a central processing unit (CPU), a micro processing unit (MPU), a digital signal processor (DSP), a graphical processing unit (GPU), or a field programmable gate array (FPGA). The storage unit (not illustrated) is a storage area for storing and retaining various data, and may be implemented by, for example, a non-volatile storage area such as a read only memory (ROM) or a hard disk drive (HDD), or a volatile storage area such as a random access memory (RAM). For example, the control unit may read and execute various data and programs stored in the storage unit to achieve various functions such as a communication function of the arithmetic device C1.

The cloud environment 10 includes a communication circuit 11, a software defined radio 12, and a device control circuit 13. The communication circuit 11 transmits and receives data between the cloud environment 10 and other systems, devices, and the like. The software defined radio 12 processes data output from a device 22, which will be described later. The device control circuit 13 controls the device 22 described later via the network NW based on the data processed by the software defined radio 12. The device control circuit 13 is a so-called radio middleware.

The cloud environment 10 according to the first embodiment may be implemented as a device. A device having various functions of the cloud environment 10 according to this embodiment may be referred to as a development environment device hereinafter. The development environment device may be provided in the cloud environment 10. Similarly to the arithmetic device C1, the development environment device may include a control unit, a storage unit, and the like (not illustrated). The control unit may read and execute various data and programs stored in the storage unit to achieve various functions of the communication circuit, software defined radio, and device control circuit of the development environment device.

The device environment 20 is a physical environment in which the device 22 is provided. In the present embodiment, it is assumed that the device 22 is a radio device. The device 22 includes a tuner T1, a tuner T2, and a tuner T3. The tuner T1 and the tuner T2 are connected to an antenna A1, and the tuner T3 is connected to an antenna A2. The function and role of each tuner will be described later.

The device environment 20 further includes an arithmetic device C2. Similarly to the arithmetic device C1, the arithmetic device C2 may be implemented by a general-purpose computer device. The arithmetic device C2 may include a control unit, a storage unit, an input-output unit, and the like (which are not illustrated) in addition to a communication circuit 21. The function of the communication circuit 21 may be achieved by cooperation of a control unit and a storage unit (not illustrated). The arithmetic device C2 is capable of communicating with the cloud environment 10 via the network NW. The arithmetic device C2 transmits data output from the device 22 to the cloud environment 10 via the network NW, and receives data transmitted from the cloud environment 10 via the network NW and transmits the data to the device 22. It is preferable that the arithmetic device C2 and the device 22 are connected by an interface capable of high-speed communication, such as a universal serial bus (USB).

The user may use the arithmetic device C2 instead of the arithmetic device C1 for device development. Therefore, the arithmetic device C1 may be omitted in the device development system 1.

In the present embodiment, a case where a user develops an in-vehicle radio device will be described. For example, a radio device mounted on a high-end vehicle equipped with two antennas, that is, a high-performance vehicle, may include three tuners. In this case, two of the three tuners are used to obtain a diversity effect, and one of the three tuners is used for back search. In order to develop the radio device that can be mounted on such a high-end vehicle, a device 22 including three tuners is provided in the device environment 20. Then, the user can test the device 22 using the software defined radio 12 and the device control circuit 13 in the cloud environment 10.

Each of the antenna A1 and the antenna A2 is connected to the device 22. A signal generator (not illustrated) is attached to each of the antenna A1 and the antenna A2. Accordingly, a signal of sufficient level can be transmitted from each antenna to the device 22 for the testing of the device 22. Each tuner of the device 22 receives a signal at a set frequency. The tuner T1 and the tuner T2 receive a signal transmitted from the antenna A1, and the tuner T3 receives a signal transmitted from the antenna A2. The signal transmitted from each antenna to the device 22 is assumed to be high frequency signals, for example, in megahertz. Each tuner converts the received signal into an intermediate frequency band signal. Each tuner further converts the intermediate frequency band signal into In-Phase/Quadrature (IQ) data. The IQ data is transmitted from the device 22 to the arithmetic device C2. Then, the arithmetic device C2 transmits the IQ data to the cloud environment 10 via the network NW. The conversion of the intermediate frequency band signal into the IQ data is not limited to being performed by each tuner. For example, the device 22 may further include a part having a function of converting a signal into IQ data, or the arithmetic device C2 may be capable of achieving such a function.

The communication circuit 11 of the cloud environment 10 receives the IQ data transmitted from the device environment 20 via the network NW and transmits the IQ data to the software defined radio 12. The software defined radio 12 decodes the IQ data and converts the IQ data into a signal conforming to the broadcasting standard. Then, the software defined radio 12 extracts data such as audio and information from the signal conforming to the broadcasting standard, and transmits the data to the device control circuit 13. The device control circuit 13 performs processing such as reproducing audio or displaying information based on the data transmitted from the software defined radio 12. The audio, information, and the like are listened to and confirmed by the user. When the user wants to adjust the device 22, the user can cause the device control circuit 13 to transmit an instruction. The device control circuit 13 transmits the instruction for the device 22 to the communication circuit 11 via the software defined radio 12 or directly. The instruction for the device 22 from the device control circuit 13, for example, a command or a control signal is transmitted from the communication circuit 11 to the arithmetic device C2 via the network NW. Then, the instruction for the device 22 is transmitted from the arithmetic device C2 to the device 22.

In this way, when a test or the like of the device 22 is performed, the IQ data required for processing by the software defined radio 12 is transferred from the device environment 20 to the cloud environment 10. Here, it is assumed that a transfer rate of 24 MB/s is required. This is the transfer rate required when 2×10⁶ pieces of IQ data are transferred per second, one piece of IQ data is 16 bits, and there are three tuners.

However, when data is transferred between the device environment 20 and the cloud environment 10 via the network NW, it may be difficult to maintain the required transfer rate. In order to cover a temporary decrease in the transfer rate, it is conceivable to provide a transmission buffer on the transmission side, that is, the communication circuit 21 of the device environment 20, and to provide a reception buffer on the reception side, that is, the communication circuit 11 of the cloud environment 10. However, even if these buffers are provided, if the transfer rate is significantly reduced, the transmission buffer may overflow, the reception buffer may become depleted, or both may occur. In this case, processing by the software defined radio 12 in the cloud environment 10 may stop or the software defined radio 12 may operate discontinuously, which may result in problems such as data loss.

In the present embodiment, if a measured transfer rate is lower than the required transfer rate, the device control circuit 13 lowers the required transfer rate to the extent that problems do not occur in the device development. As a result, the device control circuit 13 can reduce data loss or the like due to restrictions on the transfer rate, and improve the efficiency of device development for the user.

In order to reduce the required transfer rate, the device control circuit 13 causes the device 22 to stop outputting data from a specific tuner among the three tuners included in the device 22. In the present embodiment, among the tuner T1, the tuner T2, and the tuner T3, the tuner T3 is used as a sub-tuner for obtaining the diversity effect. Therefore, if the diversity effect is not evaluated in device development, the output of data from the tuner T3 is not essential. When the device control circuit 13 stops the output of data from the tuner T3, the required transfer rate is two-thirds.

The tuner T1 and the tuner T2 operate while switching roles as follows. For example, the tuner T1 receives a signal of a set frequency and the tuner T2 performs a back search, or the tuner T2 receives a signal of a set frequency and the tuner T1 performs a back search. Receiving a signal of a set frequency means, in other words, receiving a broadcast selected by the user. When a back search operation is not required in device development, it is not essential to output data from the tuner that is performing the back search. If the device control circuit 13 stops the output of data from the tuner that performs the back search, either the tuner T1 or the tuner T2, the required transfer rate can be further reduced. For example, if the device control circuit 13 stops the output of data from each of the tuner T2 and the tuner T3, the required transfer rate becomes one-third of the originally required transfer rate.

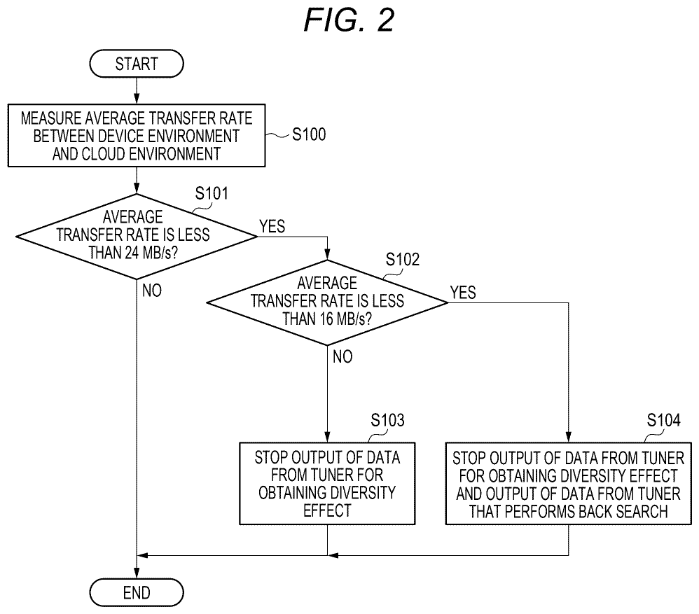

Next, a first example of a transfer rate reduction process according to the first embodiment will be described with reference to FIG. 2. FIG. 2 is a flowchart illustrating the first example of the transfer rate reduction process according to the first embodiment. Each process of the flowchart illustrated in FIG. 2 may be performed by the device control circuit 13 of the cloud environment 10, for example, when a user operates the arithmetic device C1. In the following description, it is assumed that the device control circuit 13 performs each process in the flowchart shown in FIG. 2. Further, it is assumed that a transfer rate required in device development is 24 MB/s.

The device control circuit 13 measures an average transfer rate between the device environment 20 and the cloud environment 10 (step S100). For example, the device control circuit 13 may measure an average transfer rate in a predetermined period of time that is set in advance by a user operation or the like.

The device control circuit 13 determines whether the average transfer rate measured in step S100 is less than 24 MB/s (step S101). The transfer rate not being less than a certain value means that the transfer rate is equal to or greater than the value.

When it is determined that the average transfer rate measured in step S100 is not less than 24 MB/s (step S101: NO), the device control circuit 13 ends the processing flow. This is because the actual transfer rate is equal to or greater than the required transfer rate, and thus the device control circuit 13 does not need to reduce the required transfer rate. When it is determined that the average transfer rate measured in step S100 is less than 24 MB/s (step S101: YES), the device control circuit 13 determines whether the average transfer rate measured in step S100 is less than 16 MB/s (step S102).

When it is determined that the average transfer rate measured in step S100 is not less than 16 MB/s (step S102: NO), the device control circuit 13 stops the output of data from the tuner T3 for obtaining the diversity effect (step S103). Then, the device control circuit 13 ends the processing flow. By stopping the output of data from the tuner T3, the required transfer rate becomes two-thirds of 24 MB/s, that is, 16 MB/s. As a result, the device control circuit 13 can reduce the occurrence of problems such as data loss in device development.

When it is determined that the average transfer rate measured in step S100 is less than 16 MB/s (step S102: YES), the device control circuit 13 stops the output of data from the tuner T3 for obtaining the diversity effect and the output of data from the tuner that performs the back search (step S104). The tuner that performs the back search is the tuner T1 or the tuner T2. Then, the device control circuit 13 ends the processing flow. By stopping the output of data from two of three tuners included in the device 22, the required transfer rate becomes one-third of 24 MB/s, that is, 8 MB/s. As a result, the device control circuit 13 can reduce the occurrence of problems such as data loss in device development.

In the present embodiment, the required transfer rate is described as 24 MB/s. In step S101 of the flowchart illustrated in FIG. 2, the required transfer rate is used as the determination criterion. In addition, in step S102, the value of two-thirds of the required transfer rate has been described as the determination criterion. However, these numerical values are merely examples, and the device control circuit 13 may determine whether the measured average transfer rate is less than a predetermined first threshold value in step S101. In step S102, the device control circuit 13 may determine whether the measured average transfer rate is less than a predetermined second threshold value.

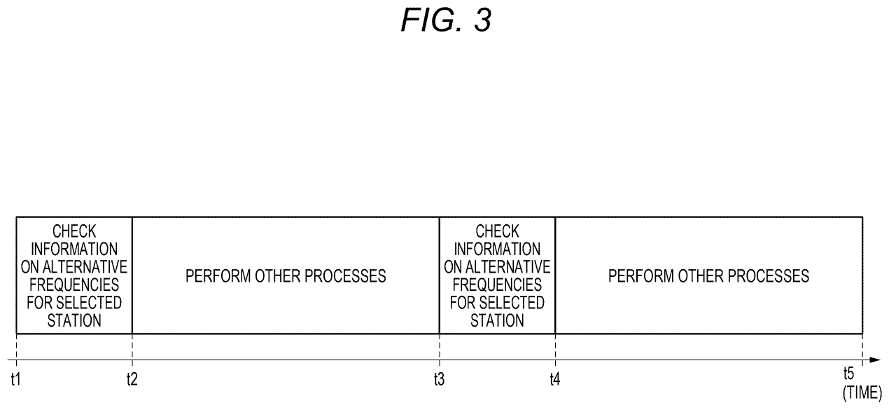

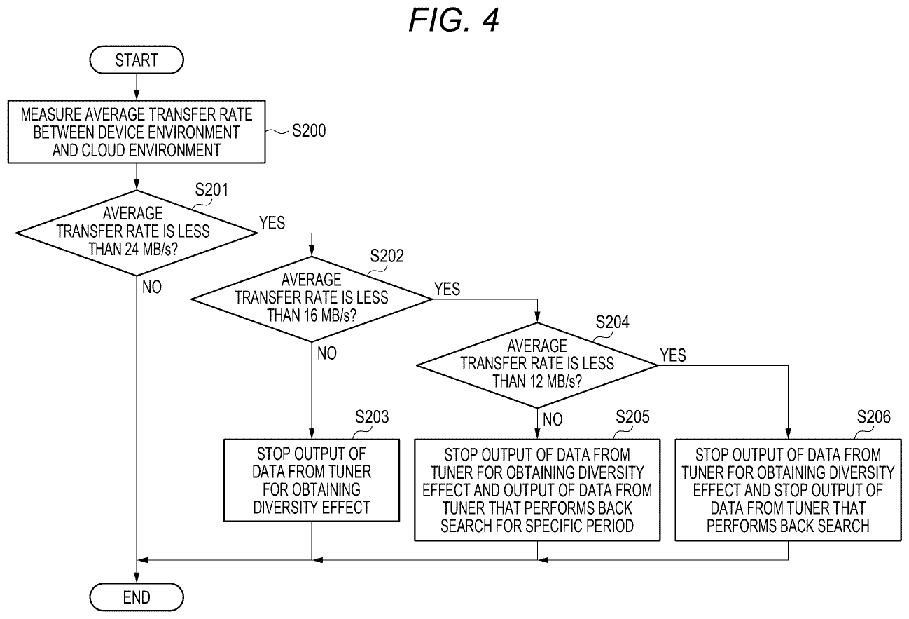

Next, a second example of a transfer rate reduction process according to the first embodiment will be described with reference to FIGS. 3 and 4. FIG. 3 is a schematic diagram illustrating the role of the tuner that performs the back search according to the first embodiment.

The tuner that performs the back search operates while switching the role at regular time intervals. FIG. 3 shows the operation of a tuner that performs a back search. The tuner that performs the back search checks information on alternative frequencies for a selected station from time t1 to time t2. That is, the tuner that performs the back search searches for alternative frequencies to the frequency of the broadcast currently selected by the user. Then, the tuner that performs the back search performs other processes from time t2 to time t3. Other processes may include, for example, searching for a broadcast other than the currently selected broadcast. Then, the tuner that performs the back search performs the back search from time t3 to time t4, and performs other processes from time t4 to time t5. As described above, the tuner that performs the back search alternately performs a search process for an alternative frequency and the other processes at regular time intervals. In the second example of the transfer rate reduction process according to the first embodiment, depending on the measured average transfer rate, the device control circuit 13 completely stops the output of data from the tuner that performs the back search, or stops it for a specific period during which a process other than the search process for an alternative frequency is being performed.

FIG. 4 is a flowchart illustrating the second example of the transfer rate reduction process according to the first embodiment. Each process of the flowchart illustrated in FIG. 4 may be performed by the device control circuit 13 of the cloud environment 10, for example, when a user operates the arithmetic device C1. In the following description, it is assumed that the device control circuit 13 performs each process in the flowchart shown in FIG. 4. Further, it is assumed that a transfer rate required in device development is 24 MB/s.

The device control circuit 13 measures an average transfer rate between the device environment 20 and the cloud environment 10 (step S200). For example, the device control circuit 13 may measure an average transfer rate in a predetermined period of time that is set in advance by a user operation or the like.

The device control circuit 13 determines whether the average transfer rate measured in step S200 is less than 24 MB/s (step S201).

When it is determined that the average transfer rate measured in step S200 is not less than 24 MB/s (step S201: NO), the device control circuit 13 ends the processing flow. This is because the actual transfer rate is equal to or greater than the required transfer rate, and thus the device control circuit 13 does not need to reduce the required transfer rate.

When it is determined that the average transfer rate measured in step S200 is less than 24 MB/s (step S201: YES), the device control circuit 13 determines whether the average transfer rate measured in step S100 is less than 16 MB/s (step S202).

When it is determined that the average transfer rate measured in step S200 is not less than 16 MB/s (step S202: NO), the device control circuit 13 stops the output of data from the tuner T3 for obtaining the diversity effect (step S203). Then, the device control circuit 13 ends the processing flow. By stopping the output of data from the tuner T3, the required transfer rate becomes two-thirds of 24 MB/s, that is, 16 MB/s. As a result, the device control circuit 13 can reduce the occurrence of problems such as data loss in device development.

When it is determined that the average transfer rate measured in step S200 is less than 16 MB/s (step S202: YES), the device control circuit 13 determines whether the average transfer rate measured in step S200 is less than 12 MB/s (step S204).

When it is determined that the average transfer rate measured in step S200 is not less than 12 MB/s (step S204: NO), the device control circuit 13 stops the output of data from the tuner T3 for obtaining the diversity effect and the output of data from the tuner that performs the back search for a specific period (step S205). The tuner that performs the back search is the tuner T1 or the tuner T2. Here, the specific period is a period during which the tuner that performs the back search performs a process other than the search process for an alternative frequency to the currently selected broadcast frequency. In other words, the device control circuit 13 does not stop the output of data from the tuner that performs the back search during a period in which the tuner is searching for an alternative frequency to the currently selected broadcast frequency. As a result, the device control circuit 13 can reduce the required transfer rate while still allowing the tuner that performs the back search to search for an alternative frequency to the currently selected broadcast frequency.

When it is determined that the average transfer rate measured in step S200 is less than 12 MB/s (step S204: YES), the device control circuit 13 stops the output of data from the tuner T3 for obtaining the diversity effect and the output of data from the tuner that performs the back search (step S206). The tuner that performs the back search is the tuner T1 or the tuner T2. Then, the device control circuit 13 ends the processing flow. By stopping the output of data from two of three tuners included in the device 22, the required transfer rate becomes one-third of 24 MB/s, that is, 8 MB/s. As a result, the device control circuit 13 can reduce the occurrence of problems such as data loss in device development.

In step S201 of the flowchart illustrated in FIG. 4, the required transfer rate is used as the determination criterion. In addition, in step S204, the value of half the required transfer rate has been described as the determination criterion. However, these numerical values are merely examples, and the device control circuit 13 may determine whether the measured average transfer rate is less than a predetermined third threshold value in step S204.

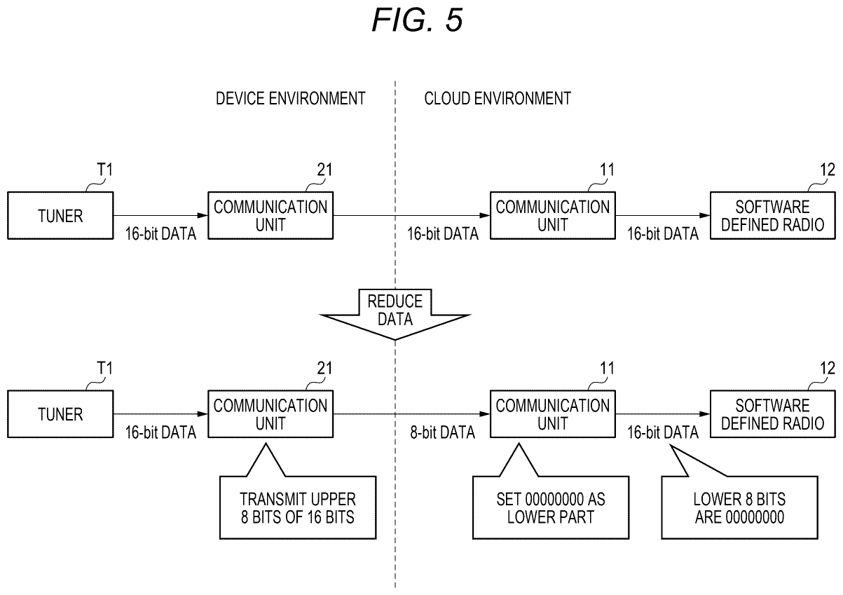

Next, a method of reducing the required transfer rate by reducing the number of bits of IQ data to be transferred from the device environment 20 to the cloud environment 10 will be described with reference to FIG. 5. FIG. 5 is a schematic diagram illustrating an example of the transfer rate reduction method according to the first embodiment.

For the sake of explanation, FIG. 5 shows an example in which one piece of IQ data is transferred from the tuner T1 to the software defined radio 12. In the related art, first, 16-bit data is transmitted from the tuner T1 to the communication circuit 21 in the device environment 20. Then, the 16-bit data is transmitted from the communication circuit 21 of the device environment 20 to the communication circuit 11 of the cloud environment 10 via the network NW. Then, the 16-bit data is transmitted from the communication circuit 11 to the software defined radio 12 in the cloud environment 10.

Next, a case where the device control circuit 13 reduces the required transfer rate will be described. In order to reduce the required transfer rate, when transmitting 16-bit data from the device environment 20 to the cloud environment 10, the device control circuit 13 causes the communication circuit 21 to transmit the upper 8 bits of the data, excluding the lower 8 bits. Accordingly, 8-bit data is transmitted from the device environment 20 to the cloud environment 10 via the network NW. Accordingly, the required transfer rate is reduced. When the originally required transfer rate is 24 MB/s, the required transfer rate becomes 12 MB/s by changing the data to be transferred from 16 bits to 8 bits. The communication circuit 11 of the cloud environment 10 receives the 8-bit data. The communication circuit 11 sets the received 8 bits as the upper part of the 16-bit data, and sets each of the 8 bits of the lower part of the 16-bit data to 0. Accordingly, the communication circuit 11 obtains 16-bit data in which the lower 8 bits are each set to 0. The communication circuit 11 transmits the 16-bit data to the software defined radio 12. The software defined radio 12 receives the 16-bit data in which the lower 8 bits are each set to 0.

The upper 8 bits of the data received by the software defined radio 12 are the same as the upper 8 bits of the data output from the tuner T1. However, since each of the lower 8 bits of the data received by the software defined radio 12 is 0, the accuracy of the data is reduced. Specifically, the sound quality deteriorates. At this time, by transmitting a signal of a sufficient level from the antenna A1 to the tuner T1, it is possible to reduce deterioration of the sound quality to an extent that problems do not occur in the device development.

FIG. 5 illustrates an example in which the upper 8 bits of 16-bit data are transmitted. However, the present invention is not limited thereto, and the device control circuit 13 can further reduce the required transfer rate by further reducing the number of bits to be transmitted.

The method of reducing the number of bits of data to be transmitted from the device environment 20 to the cloud environment 10 may be combined with the method of stopping the output of data from a specific tuner, as described with reference to FIG. 2, FIG. 4, or the like.

### Summary of First Embodiment

The above description of the first embodiment discloses at least the following techniques. Components corresponding to those in the first embodiment are illustrated in parentheses, but the present disclosure is not limited thereto.

### (Technique 1)

A development environment device (for example, cloud environment 10) connected via a predetermined communication network (for example, network NW) to a device environment (for example, device environment 20) that includes a target device (for example, device 22) having a plurality of tuners (for example, tuner T1, tuner T2, tuner T3), the development environment device includes: a software defined radio (for example, software defined radio 12) configured to process data from the target device; and a device control circuit (for example, device control circuit 13) configured to control an operation of the target device based on an output from the software defined radio, in which the software defined radio is configured to decode data corresponding to an output signal from the tuner which is transmitted from the device environment via the communication network, and to output the decoded data to the device control circuit, and in which the device control circuit is configured to determine whether to stop output of data corresponding to an output signal from at least one of the plurality of tuners based on a transfer rate of the data in the communication network, and when it is determined to stop the output of data corresponding to an output signal from at least one of the plurality of tuners, transmit a stop instruction to the device environment.

Accordingly, the development environment device, which is capable of data communication with the device environment in which the device is provided, can stop a part of the output from the device based on the transfer rate of the data between the device environment and the development environment device. As a result, the transfer rate required for device development on the development environment device is reduced, and the efficiency of the device development is improved.

### (Technique 2)

In the development environment device according to Technique 1, one of the plurality of tuners is a sub-tuner for obtaining a diversity effect with the other tuners, and the device control circuit may be configured to, when the transfer rate is less than a predetermined first threshold value, transmit to the device environment the instruction to stop output of data corresponding to an output signal from the sub-tuner.

Accordingly, for example, if a function for obtaining a diversity effect is not required in a test for the device development, the development environment device can stop the function according to the measured transfer rate. Accordingly, the development environment device can reduce the transfer rate required for the device development.

### (Technique 3)

In the development environment device according to Technique 2, one of the plurality of tuners is a tuner for back search, and the device control circuit may be configured to, when the transfer rate is less than a predetermined second threshold value that is smaller than the first threshold value, further transmit to the device environment the instruction to stop output of data corresponding to an output signal from the tuner for back search.

Accordingly, for example, if a back search function is not required in a test for the device development, the development environment device can stop the function according to the measured transfer rate. Accordingly, the development environment device can reduce the transfer rate required for the device development.

### (Technique 4)

In the development environment device according to Technique 3, the tuner for back search may perform a search process of searching for an alternative frequency of a currently selected broadcast and a process other than the search process, and the device control circuit may be configured to, when the transfer rate is less than the second threshold value and is equal to or greater than a predetermined third threshold value smaller than the second threshold value, transmit to the device environment the instruction to stop output of data corresponding to an output signal during a period in which the tuner for back search is performing a process other than the search process, and when the transfer rate is less than the third threshold value, transmit to the device environment the instruction to stop the output of data corresponding to an output signal from the tuner for back search.

As a result, the development environment device can stop the output of data from

the tuner for back search during a period in which the tuner performs a specific function that is not required for a test of the device development. Accordingly, the development environment device can reduce the transfer rate required for the device development.

### (Technique 5)

In the development environment device according to any one of Technique 1 to Technique 4, when transmitting data corresponding to the output signal from the device environment to the development environment device, the device control circuit may transmit a predetermined number of upper bits of the data excluding a predetermined number of lower bits, and the software defined radio may receive data including the upper bits and the predetermined number of zeros by setting each of the lower bits to zero.

Accordingly, the development environment device can reduce data transferred via the communication network within a range in which problems do not occur in the device development. Accordingly, the development environment device can reduce the transfer rate required for the device development.

### (Technique 6)

In the development environment device according to any one of Technique 1 to Technique 5, the target device may be provided in a physical environment, and the development environment device may be provided in a virtual environment.

Accordingly, the device is provided in the physical environment, and the development environment device is provided in the virtual environment.

### (Technique 7)

A device control method includes: in a predetermined communication network connecting a device environment that includes a target device having a plurality of tuners and a development environment device that controls an operation of the target device, determining whether to stop output of data corresponding to an output signal from at least one of the plurality of tuners based on a transfer rate of data corresponding to an output signal from the tuner; and when it is determined to stop the output of data corresponding to an output signal from at least one of the plurality of tuners, transmitting a stop instruction to the device environment.

Accordingly, the device control method can attain the same effects as those of Technique 1.

### (Technique 8)

A program for causing a development environment device to execute following processes, the development environment device being connected via a predetermined communication network to a device environment that includes a target device having a plurality of tuners and being configured to control an operation of the target device, the processes includes: determining whether to stop output of data corresponding to an output signal from at least one of the plurality of tuners based on a transfer rate of data corresponding to an output signal from the tuner in the communication network; and when it is determined to stop the output of data corresponding to an output signal from at least one of the plurality of tuners, transmitting a stop instruction to the device environment.

Accordingly, the program can obtain effects similar to those of the Technique 1.

### Second Embodiment

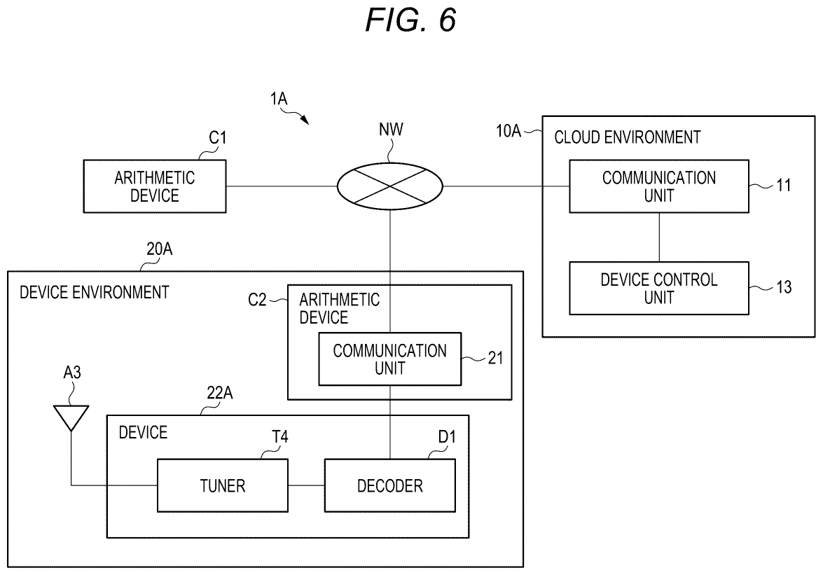

FIG. 6 is a block diagram illustrating an example of the configuration of a device development system 1A according to a second embodiment. In the first embodiment, an example in which the software defined radio 12 is incorporated into the cloud environment 10 in the device development system 1 has been described. On the other hand, in the device development system 1A according to the second embodiment, the software defined radio 12 is not incorporated into a cloud environment 10A. In the first embodiment, the software defined radio 12 decodes the IQ data, but in the second embodiment, the IQ data is decoded on a device environment 20A side. Accordingly, the number of times of transfer of data such as a control command between the device control circuit 13, which is radio middleware, and a device 22A increases, and the possibility of occurrence of data delay also increases.

Therefore, in the second embodiment, the configuration of the device development system 1A that reduces the influence of a delay in data transfer between the device environment 20A and the cloud environment 10A in device development and achieves improvement in efficiency of device development will be described. In the description of the device development system 1A according to the second embodiment, the description of the same contents as those of the device development system 1 according to the first embodiment will be simplified or omitted, and the description will focus on differences.

The device development system 1A includes the arithmetic device C1, the cloud environment 10A, and the device environment 20A. Each unit included in the device development system 1 is connected by a network NW.

The cloud environment 10A includes the communication circuit 11 and the device

control circuit 13. Unlike the cloud environment 10 according to the first embodiment, the cloud environment 10A does not include the software defined radio 12.

The device environment 20A includes the device 22A and the arithmetic device C2. The device 22A includes a tuner T4 and a decoder D1. The tuner T4 is connected to an antenna A3. A signal generator (not illustrated) is attached to the antenna A3, and a signal of a sufficient level is transmitted from the antenna A3 to the device 22A for the testing of the device 22A. For convenience of description, an example in which the device 22A includes one tuner T4 is shown, but the device 22A may include a plurality of tuners.

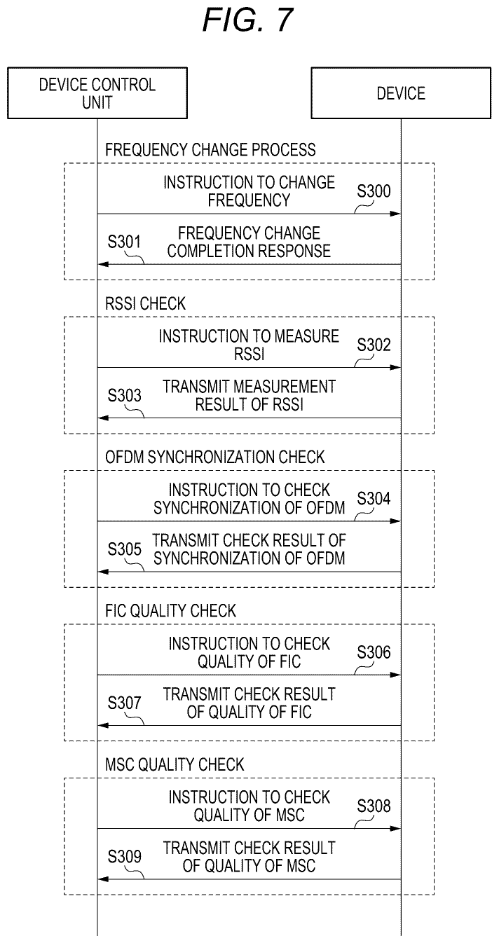

In the first embodiment, the IQ data is transferred from the device environment 20 to the cloud environment 10, and the software defined radio 12 in the cloud environment 10 decodes the IQ data. In the second embodiment, the decoder D1 of the device 22A decodes the IQ data output from the tuner T4. Then, the decoded data is transferred from the device environment 20A to the cloud environment 10A via the network NW. In the second embodiment, since decoding is required on the device environment 20A side, the number of times data transfer between the cloud environment 10A and the device environment 20A may increase as compared with the case of the first embodiment. As a result, the possibility of data delay increases. A specific example will be described with reference to FIG. 7.

FIG. 7 is a sequence diagram of a Seek process in the related art. The Seek process is a process for searching for a signal that satisfies a specific condition. An example in which the device control circuit 13 transmits and receives data to and from the device 22A for a seek process in the related art will be described with reference to FIG. 7. Here, the device control circuit 13 searches for a broadcast signal of a digital audio broadcast.

In the Seek process of related art, first, the device control circuit 13 transmits an instruction to change the reception frequency of the tuner T4 to the device 22A (step S300). The tuner T4 receives a signal at the set reception frequency. Therefore, in the Seek process, the device control circuit 13 searches for a signal that satisfies a specific condition while changing the reception frequency of the tuner T4. The range of change in the reception frequency, in other words, the range of frequencies that are the target of the Seek process, may be set in advance by the user, for example.

The device 22A that has received the instruction to change the reception frequency changes the reception frequency based on the change instruction. Then, the device 22A transmits a change completion response of the reception frequency to the device control circuit 13 (step S301). Hereinafter, the process from step S300 to step S301 performed between the device control circuit 13 and the device 22A may be referred to as “frequency change process”.

The device control circuit 13 receives the change completion response of the reception frequency from the device 22A. Then, the device control circuit 13 transmits an instruction to measure a received signal strength indicator (RSSI) to the device 22A (step S302).

Upon receiving the instruction to measure the RSSI, the device 22A measures the RSSI. Briefly, device 22A measures the strength of the signal of the set reception frequency. Then, the device 22A transmits a measurement result of the RSSI to the device control circuit 13 (step S303). Hereinafter, the process from step S302 to step S303 performed between the device control circuit 13 and the device 22A may be referred to as “RSSI check”.

The device control circuit 13 receives the measurement result of the RSSI from the device 22A. The device control circuit 13 may have a criterion for determining whether the measurement result of the RSSI is pass or fail. If the measurement result of the RSSI is fail, the device control circuit 13 returns to step S300 and executes the process from the frequency change process. Here, it is assumed that the device control circuit 13 determines that the measurement result of the RSSI is pass, and the process proceeds to the next step S304.

The device 22A may have the criterion for determining whether the measurement result of the RSSI is pass or fail, and may transmit the pass or fail of the measurement result of the RSSI to the device control circuit 13.

The device control circuit 13 transmits an instruction to check synchronization of orthogonal frequency division multiplexing (OFDM) to the device 22A (step S304).

Upon receiving the instruction to check the synchronization of OFDM, the device 22A checks the synchronization of OFDM. Briefly, the device 22A checks whether orthogonality between subcarriers is achieved. Then, the device 22A transmits the check result of the synchronization of OFDM to the device control circuit 13 (step S305). Hereinafter, the process from step S304 to step S305 performed between the device control circuit 13 and the device 22A may be referred to as “OFDM synchronization check”.

The device control circuit 13 receives the check result of the synchronization of OFDM from the device 22A. Here, the device 22A may determine whether the synchronization of OFDM is achieved based on a received signal, and transmit a determination result to the device control circuit 13. Alternatively, the device control circuit 13 may determine whether the synchronization of OFDM is achieved based on data received from the device 22A. The device 22A or the device control circuit 13 may have a criterion for determining whether the synchronization of OFDM is achieved. If the check result of the synchronization of OFDM is fail, the device control circuit 13 returns to step S300 and executes the process from the frequency change process. Here, it is assumed that the device control circuit 13 determines that the check result of the synchronization of OFDM is pass, and the process proceeds to the next step S306.

The device control circuit 13 transmits an instruction to check the quality of the fast information channel (FIC) of the digital audio broadcast to the device 22A (step S306).

Upon receiving the instruction to check the quality of FIC, the device 22A checks the quality of FIC. Specifically, the device 22A checks the strength or error rate of a signal transmitted through the FIC. Then, the device 22A transmits the check result of the quality of FIC to the device control circuit 13 (step S307). Hereinafter, the process from step S306 to step S307 performed between the device control circuit 13 and the device 22A may be referred to as “FIC quality check”.

The device control circuit 13 receives the check result of the quality of FIC from the device 22A. Here, the device 22A may have a criterion for determining whether the quality of FIC is pass or fail. Then, the device 22A may transmit to the device control circuit 13 the pass or fail of the quality of FIC based on the criteria as a check result of the quality of FIC. Alternatively, the device control circuit 13 may have the criterion for determining whether the quality of FIC is pass or fail. In this case, the device control circuit 13 may determine whether the quality of FIC is pass or fail based on data received from the device 22A. If the quality of FIC is fail, the device control circuit 13 returns to step S300 and executes the process from the frequency change process. Here, it is assumed that the device control circuit 13 determines that the check result of the quality of FIC is pass, and the process proceeds to the next step S308.

The device control circuit 13 transmits an instruction to check the quality of the main service channel (MSC) of the digital audio broadcast to the device 22A (step S308).

Upon receiving the instruction to check the quality of MSC, the device 22A checks the quality of MSC. Specifically, the device 22A checks the strength or error rate of a signal transmitted through the MSC. Then, the device 22A transmits the check result of the quality of MSC to the device control circuit 13 (step S309). Hereinafter, the process from step S308 to step S309 performed between the device control circuit 13 and the device 22A may be referred to as “MSC quality check”.

The device control circuit 13 receives the check result of the quality of MSC from the device 22A. Here, the device 22A may have a criterion for determining whether the quality of MSC is pass or fail. Then, the device 22A may transmit to the device control circuit 13 the pass or fail of the quality of MSC based on the criteria as a check result of the quality of MSC. Alternatively, the device control circuit 13 may have the criterion for determining whether the quality of MSC is pass or fail. In this case, the device control circuit 13 may determine whether the quality of MSC is pass or fail based on data received from the device 22A. If the quality of MSC is fail, the device control circuit 13 returns to step S300 and executes the process from the frequency change process. If the quality of MSC is pass, for example, the device control circuit 13 transmits an instruction to the device 22A to set the current frequency as the reception frequency.

In this way, in the Seek process of related art, a plurality of checks are performed in a stepwise manner between the cloud environment 10A and the device environment 20A. Data is exchanged between the cloud environment 10A and the device environment 20A via the network NW, and therefore the more times data is transferred, the longer the data delay time becomes. For example, if a data delay of 10 ms occurs one way, a delay of about 20 ms may occur in the round trip. When data exchange is performed five times as in the example of FIG. 7, the data delay time may be approximately 100 ms. Such a large data delay time may make a user who performs the device development feel uncomfortable with the hardware environment in which the actual device is to be provided. That is, problems may occur in the device development.

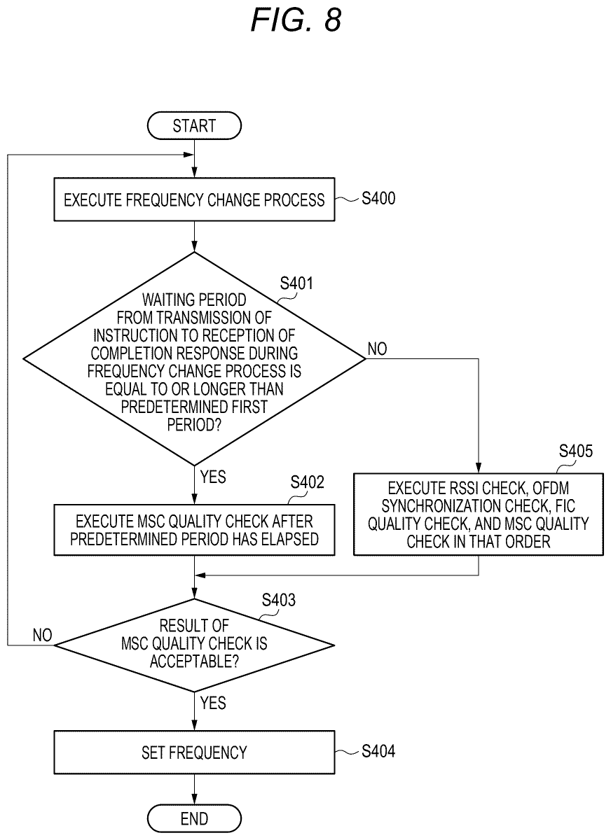

Therefore, in the second embodiment, the device development system 1A reduces the number of times of data transfer within a range in which problems do not occur in the device development of the user. A specific example will be described with reference to FIGS. 8 to 10.

FIG. 8 is a flowchart illustrating a first example of the Seek process according to the second embodiment. The seek process is performed by the device control circuit 13 and the device 22A working together, but for convenience, the device control circuit 13 will be mainly described.

First, the device control circuit 13 executes a frequency change process (step S400). The device control circuit 13 transmits an instruction to change the reception frequency to the device 22A, and receives a change completion response to the change instruction from the device 22A.

The device control circuit 13 determines whether a waiting period from the transmission of the change instruction to the device 22A until the reception of the change completion response from the device 22A during the frequency change process in step S400 is equal to or longer than a predetermined first period (step S401). Hereinafter, a waiting period from when the device control circuit 13 transmits the change instruction to when it receives the change completion response during the frequency change process in step S400 may be referred to as a first waiting period. The predetermined first period may be set in advance by the user, for example.

First, a case where the device control circuit 13 determines that the first waiting period is equal to or longer than the predetermined first period will be described.

When it is determined that the first waiting period is equal to or longer than the predetermined first period (step S401: YES), the device control circuit 13 executes the MSC quality check after a predetermined period has elapsed (step S402). The predetermined period will be described later together with the description of step S405.

The device control circuit 13 determines whether a result of the MSC quality check is acceptable (step S403). That is, the device control circuit 13 determines whether the quality of the MSC is pass or fail. A case where the result of the MSC quality check is acceptable is a case where the device control circuit 13 determines that the quality of the MSC is pass. A case where the result of the MSC quality check is not acceptable is a case where the device control circuit 13 determines that the quality of the MSC is fail.

If it is determined that the result of the MSC quality check is acceptable (step S403: YES), the device control circuit 13 sets the reception frequency of the device 22A to the current frequency, in other words, the reception frequency obtained after changing in the process of step S400 (step S404). Then, the device control circuit 13 ends the processing flow.

When it is determined that the result of the MSC quality check is not acceptable (step S403: NO), the device control circuit 13 returns to step S400 and repeats the process. Thus, the MSC quality check or the like is performed at a frequency different from the current frequency.

Even if it is determined that the result of the MSC quality check is acceptable, the device control circuit 13 may return to step S400 and repeat the process at a frequency different from the current frequency. Such settings may be optionally made by the user who performs the device development.

Next, a case where the device control circuit 13 determines that the first waiting period is shorter than the predetermined first period will be described.

When it is determined that the first waiting period is shorter than the predetermined first period (step S401: NO), the device control circuit 13 executes the RSSI check, the OFDM synchronization check, the FIC quality check, and the MSC quality check in that order (step S405). For the sake of convenience, it is assumed that the RSSI check, the OFDM synchronization check, and the FIC quality check all pass, and the device control circuit 13 proceeds with the process up to the MSC quality check. Then, the device control circuit 13 advances the process to step S403.

During the frequency change process in step S400 and the various checks in step S405, the device control circuit 13 transmits instructions to the device 22A. The device control circuit 13 transmits these instructions at a preset transmission interval. For example, the device control circuit 13 may be configured to transmit the next instruction 100 ms after receiving a response to any instruction. This allows the device control circuit 13 to exchange data with the device 22A at a constant cycle.

However, if the waiting period from the transmission of the instruction to the device 22A to the response from the device 22A to the instruction is equal to or longer than a predetermined period, the device control circuit 13 may change the transmission interval of the instruction to the device 22A. For example, the device control circuit 13 may extend the transmission interval at which instructions are transmitted to the device 22A from the next time onwards to a transmission interval that is longer than the current transmission interval. As a more specific example, the device control circuit 13 may extend the interval from the reception of the response from the device 22A to the transmission of the next instruction to the device 22A from 100 ms to 1 s.

If the device control circuit 13 determines in step S401 that the first waiting period is equal to or longer than the predetermined first period, the device control circuit 13 extends the transmission interval at which instructions are transmitted to the device 22A. Therefore, the predetermined period that the device control circuit 13 waits for to elapse in step S402 is a period extended from the set transmission interval. When performing each check in step S405, the device control circuit 13 also transmits an instruction to the device 22A after a predetermined period has elapsed. However, the transmission interval for the instruction in step S405 is a preset transmission interval. In the above description of step S402, the phrase “after a predetermined period has elapsed” is used to emphasize that the transmission interval for the instruction is extended.

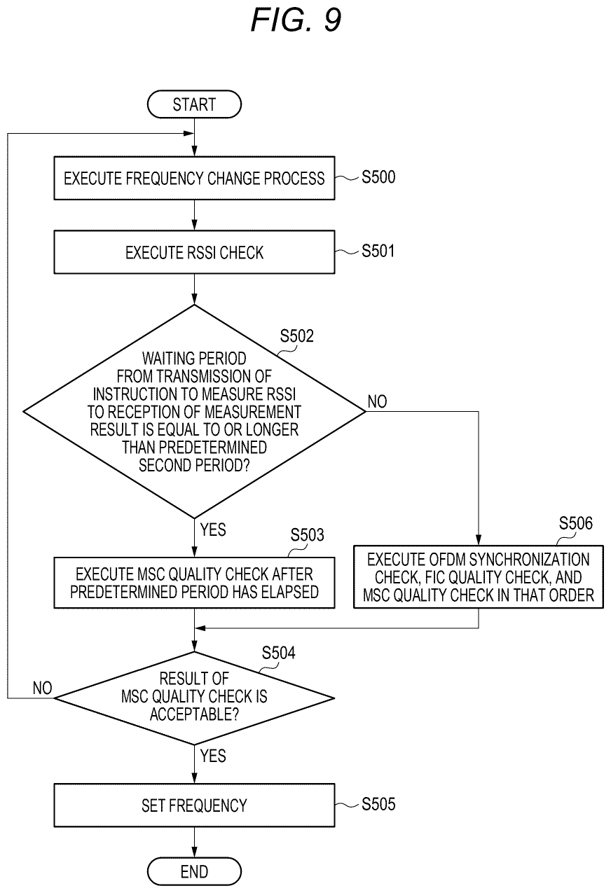

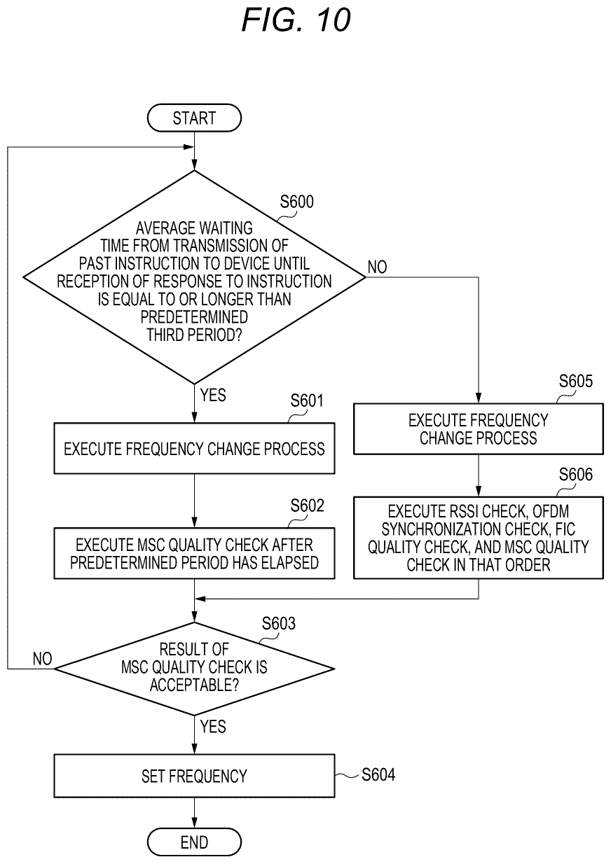

The description regarding the “predetermined period” in step S402 also applies to the “predetermined period” in step S503 of FIG. 9 and the “predetermined period” in step S602 of FIG. 10.

As described with reference to FIG. 8, the device control circuit 13 may execute the frequency change process regardless of the waiting time from the transmission of an instruction to the device 22A to the reception of response. If the first waiting period is equal to or longer than the first period, the device control circuit 13 may omit transmission and reception during a plurality of checks that are performed when the reception frequency of the tuner T4 is changed. Examples of the plurality of checks performed when the reception frequency of the tuner T4 is changed include, for example, the RSSI check, the OFDM synchronization check, the FIC quality check, and the MSC quality check. Then, the device control circuit 13 may perform transmission and reception for the last check among the plurality of checks with the device environment 20A. In the example of FIG. 8, if the first waiting period is equal to or longer than the first period, the device control circuit 13 omits transmission and reception for the RSSI check, the OFDM synchronization check, and the FIC quality check. Then, the device control circuit 13 performs the last check, that is, transmission and reception for the MSC quality check, with the device environment 20A. As a result, the device control circuit 13 can reduce the number of times of data transfer and reduce the delay time in data transfer during the device development. Accordingly, the device control circuit 13 can improve the efficiency of the device development.

FIG. 9 is a flowchart illustrating a second example of the Seek process according to the second embodiment. In the description of FIG. 9, a part overlapping the description of FIG. 8 may be omitted or simplified.

First, the device control circuit 13 executes a frequency change process (step S500). The device control circuit 13 transmits an instruction to change the reception frequency to the device 22A, and receives a change completion response to the change instruction from the device 22A.

The device control circuit 13 executes the RSSI check using the reception frequency obtained after the changing in step S500 (step S501). The device control circuit 13 transmits an instruction to measure RSSI to the device 22A, and receives a measurement result in response to the instruction from the device 22A.

The device control circuit 13 determines whether a waiting period from the transmission of the measurement instruction to the device 22A to the reception of the measurement result from the device 22A during the RSSI check in step S501 is equal to or longer than a predetermined second period (step S502). Hereinafter, a waiting period from when the device control circuit 13 transmits the measurement instruction to when it receives the measurement result during the RSSI check in step S501 may be referred to as a second waiting period. The predetermined second period may be set in advance by the user, for example.

First, a case where the device control circuit 13 determines that the second waiting period is equal to or longer than the predetermined second period will be described.

When it is determined that the second waiting period is equal to or longer than the predetermined second period (step S502: YES), the device control circuit 13 executes the MSC quality check after a predetermined period has elapsed (step S503).

The device control circuit 13 determines whether a result of the MSC quality check is acceptable (step S504).

If it is determined that the result of the MSC quality check is acceptable (step S504: YES), the device control circuit 13 sets the reception frequency of the device 22A to the current frequency, in other words, the reception frequency obtained after changing in the process of step S500 (step S505). Then, the device control circuit 13 ends the processing flow.

When it is determined that the result of the MSC quality check is not acceptable (step S504: NO), the device control circuit 13 returns to step S500 and repeats the process. Even if it is determined that the result of the MSC quality check is acceptable, the device control circuit 13 may return to step S500 and repeat the process.

Next, a case where the device control circuit 13 determines that the second waiting period is shorter than the predetermined second period will be described.

When it is determined that the second waiting period is shorter than the predetermined second period (step S502: NO), the device control circuit 13 executes the OFDM synchronization check, the FIC quality check, and the MSC quality check in that order (step S506). For the sake of convenience, it is assumed that the OFDM synchronization check, and the FIC quality check all pass, and the device control circuit 13 proceeds with the process up to the MSC quality check. Then, the device control circuit 13 advances the process to step S504.

As described with reference to FIG. 9, the device control circuit 13 may execute the frequency change process and the RSSI check regardless of the waiting time from the transmission of an instruction to the device 22A to the reception of response. If the second waiting period is equal to or longer than the second period, the device control circuit 13 may omit transmission and reception during a plurality of checks that are performed when the reception frequency of the tuner T4 is changed. Examples of the plurality of checks performed when the reception frequency of the tuner T4 is changed include, for example, the OFDM synchronization check, the FIC quality check, and the MSC quality check. Then, the device control circuit 13 may perform transmission and reception for the last check among the plurality of checks with the device environment 20A. In the example of FIG. 9, if the second waiting period is equal to or longer than the second period, the device control circuit 13 omits transmission and reception for the OFDM synchronization check, and the FIC quality check. Then, the device control circuit 13 performs the last check, that is, transmission and reception for the MSC quality check, with the device environment 20A. As a result, the device control circuit 13 can reduce the number of times of data transfer and reduce the delay time in data transfer during the device development. Accordingly, the device control circuit 13 can improve the efficiency of the device development.

FIG. 10 is a flowchart illustrating a third example of the Seek process according to the second embodiment. In the description of FIG. 10, a part overlapping the description of FIG. 8 or the description of FIG. 9 may be omitted or simplified.

The device control circuit 13 determines whether an average waiting time from the transmission of a past instruction to the device 22A until the response to the instruction from the device 22A is equal to or longer than a predetermined third period (step S600). Examples of the past instruction to the device 22A include an instruction to change the frequency, an instruction to measure RSSI, an instruction to check OFDM synchronization, an instruction to check the quality of FIC, and an instruction to check the quality of MSC. For example, a history of past data transfers between the device control circuit 13 and the device 22A may be stored in the cloud environment 10A so that the device control circuit 13 can refer to the history. Accordingly, the device control circuit 13 can calculate the average waiting time from the transmission of the past instruction to the device 22A to the response to the instruction from the device 22A.

First, a case where the device control circuit 13 determines that the average waiting time from the transmission of the instruction to the device 22A to the response is equal to or longer than the predetermined third period will be described.

When it is determined that the average waiting time from the transmission of the instruction to the device 22A to the response is equal to or longer than the predetermined third period (step S600: YES), the device control circuit 13 executes the frequency change process (step S601).

Then, the device control circuit 13 executes the MSC quality check after a predetermined period has elapsed (step S602).

The device control circuit 13 determines whether a result of the MSC quality check is acceptable (step S603).

If it is determined that the result of the MSC quality check is acceptable (step S603: YES), the device control circuit 13 sets the reception frequency of the device 22A to the current frequency, in other words, the reception frequency obtained after changing in the process of step S601 (step S604). Then, the device control circuit 13 ends the processing flow.

When it is determined that the result of the MSC quality check is not acceptable (step S603: NO), the device control circuit 13 returns to step S600 and repeats the process. Even if it is determined that the result of the MSC quality check is acceptable, the device control circuit 13 may return to step S600 and repeat the process.

Next, a case where the device control circuit 13 determines that the average waiting time from the transmission of the instruction to the device 22A to the response is shorter than the predetermined third period will be described.

When it is determined that the average waiting time from the transmission of the instruction to the device 22A to the response is shorter than the predetermined third period (step S600: NO), the device control circuit 13 executes the frequency change process (step S605).

Then, the device control circuit 13 executes the RSSI check, the OFDM synchronization check, the FIC quality check, and the MSC quality check in that order (step S606). For the sake of convenience, it is assumed that the RSSI check, the OFDM synchronization check, and the FIC quality check all pass, and the device control circuit 13 proceeds with the process up to the MSC quality check. Then, the device control circuit 13 advances the process to step S603.

As described with reference to FIG. 10, the device control circuit 13 may omit the transmission and reception during the plurality of checks performed when changing the reception frequency of the tuner T4 based on the past average waiting time from the transmission of instruction to the device 22A to the reception of response. Examples of the plurality of checks performed when the reception frequency of the tuner T4 is changed include, for example, the RSSI check, the OFDM synchronization check, the FIC quality check, and the MSC quality check. In the example of FIG. 10, if the third waiting period is equal to or longer than the third period, the device control circuit 13 omits transmission and reception for the RSSI check, the OFDM synchronization check, and the FIC quality check. Then, the device control circuit 13 performs the last check, that is, transmission and reception for the MSC quality check, with the device environment 20A. As a result, the device control circuit 13 can reduce the number of times of data transfer and reduce the delay time in data transfer during the device development. Accordingly, the device control circuit 13 can improve the efficiency of the device development.

### Summary of Second Embodiment

The above description of the second embodiment discloses at least the following techniques. Components corresponding to those in the second embodiment are illustrated in parentheses, but the present disclosure is not limited thereto.

### (Technique 9)

A development environment device (for example, cloud environment 10A) connected via a predetermined communication network (for example, network NW) to a device environment (for example, device environment 20A) that includes a target device (for example, device 22A) having a tuner (for example, tuner T4), in which whether a first waiting period is equal to or longer than a predetermined first period is determined, the first waiting period being a period from transmission of a change instruction for a reception frequency of the tuner to the device environment until reception of a change completion response to the change instruction from the device environment, in which when the first waiting period is shorter than the first period, transmission and reception for a plurality of checks performed when changing the reception frequency of the tuner are sequentially performed with the device environment, and in which when the first waiting period is equal to or longer than the first period, transmission and reception during the plurality of checks are omitted, and transmission and reception for a last check are performed with the device environment.

As a result, the development environment device is connected to the device environment in which the device including the tuner is provided so as to be able to communicate data. Then, the development environment device can transmit to the device an instruction to change the reception frequency of the tuner of the device. When the waiting period until the response from the device is equal to or longer than the predetermined period, the development environment device can omit a part of the plurality of checks when changing the reception frequency of the tuner. Accordingly, the development environment device can reduce the number of times of data transfer with the device environment at the time of device development, and the efficiency of the device development is improved.

### (Technique 10)

In the development environment device according to Technique 9, when the first waiting period is shorter than the first period, a received signal strength indicator (RSSI) check, an orthogonal frequency division multiplexing (OFDM) synchronization check, a fast information channel (FIC) quality check for a digital audio broadcast, and a main service channel (MSC) quality check for the digital audio broadcast may be sequentially performed as the plurality of checks, and when the first waiting period is equal to or longer than the first period, the MSC quality check may be performed as the last check.

Accordingly, the development environment device can omit the RSSI check, the OFDM synchronization check, and the FIC quality check among the RSSI check, the OFDM synchronization check, the FIC quality check, and the MSC quality check depending on the waiting period until a response from the device environment.

### (Technique 11)

A development environment device connected via a predetermined communication network to a device environment that includes a target device having a tuner, whether a second waiting period is equal to or longer than a predetermined second period is determined, the second waiting period being a period from transmission of a measurement instruction for a received signal strength indicator (RSSI) when changing a reception frequency of the tuner to the device environment until reception of a measurement result in response to the measurement instruction from the device environment, in which when the second waiting period is shorter than the second period, transmission and reception for a plurality of checks performed when changing the reception frequency of the tuner are sequentially performed with the device environment, and in which when the second waiting period is equal to or longer than the second period, transmission and reception during the plurality of checks are omitted, and transmission and reception for a last check are performed with the device environment.

As a result, the development environment device is connected to the device environment in which the device including the tuner is provided so as to be able to communicate data. The development environment device can change the reception frequency of the tuner of the device, and can transmit to the device an instruction to check the RSSI. When the waiting period until the response from the device is equal to or longer than the predetermined period, the development environment device can omit a part of the plurality of checks when changing the reception frequency of the tuner. Accordingly, the development environment device can reduce the number of times of data transfer with the device environment at the time of device development, and the efficiency of the device development is improved.

### (Technique 12)

A development environment device connected via a predetermined communication network to a device environment that includes a target device having a tuner, in which when an average waiting period from transmission of a past instruction to the target device until a response to the instruction from the target device is shorter than a predetermined third period, transmission and reception for changing a reception frequency of the tuner are performed with the device environment, and further, transmission and reception for a plurality of checks performed at the time of the change are sequentially performed with the device environment, and in which when the average waiting period is equal to or longer than the third period, transmission and reception for the change are performed with the device environment, and further, transmission and reception during the plurality of checks are omitted, and transmission and reception for a last check are performed with the device environment.

As a result, the development environment device is connected to the device environment in which the device including the tuner is provided so as to be able to communicate data. When the average waiting time from the transmission of a past instruction to the device until the response to the instruction from the device is equal to or longer than the predetermined period, the development environment device can omit a part of the plurality of checks when changing the reception frequency of the tuner. Accordingly, the development environment device can reduce the number of times of data transfer with the device environment at the time of device development, and the efficiency of the device development is improved.

### (Technique 13)

In the development environment device according to any one of Technique 9 to Technique 12, when a waiting period from transmission of an instruction to the target device until a response to the instruction from the target device is equal to or longer than a predetermined period, a transmission interval at which instructions are transmitted to the target device from a next time onward is extended to a predetermined transmission interval that is longer than the current transmission interval.

Accordingly, when the development environment device transmits an instruction to the device and the waiting period until the response to the instruction from the device is equal to or longer than the predetermined period, the transmission interval at which the instructions are transmitted to the device from a next time onward may be extended.

### (Technique 14)

In the development environment device according to any one of Technique 9 to Technique 13, the target device may be provided in a physical environment, and the development environment device may be provided in a virtual environment.

Accordingly, the device is provided in the physical environment, and the development environment device is provided in the virtual environment.

### (Technique 15)

A device control method to be executed by a development environment device connected via a predetermined communication network to a device environment that includes a target device having a tuner, the device control method including: determining whether a first waiting period is equal to or longer than a predetermined first period, the first waiting period being a period from transmission of a change instruction for a reception frequency of the tuner to the device environment until reception of a change completion response to the change instruction from the device environment; when the first waiting period is shorter than the first period, sequentially performing transmission and reception for a plurality of checks performed when changing the reception frequency of the tuner with the device environment; and when the first waiting period is equal to or longer than the first period, omitting transmission and reception during the plurality of checks, and performing transmission and reception for a last check with the device environment.

Accordingly, the device control method can attain the same effects as those of Technique 9.

### (Technique 16)

A program for causing a development environment device to execute following processes, the development environment device being connected via a predetermined communication network to a device environment that includes a target device having a tuner, the processes including: determining whether a first waiting period is equal to or longer than a predetermined first period, the first waiting period being a period from transmission of a change instruction for a reception frequency of the tuner to the device environment until reception of a change completion response to the change instruction from the device environment; when the first waiting period is shorter than the first period, sequentially performing transmission and reception for a plurality of checks performed when changing the reception frequency of the tuner with the device environment; and when the first waiting period is equal to or longer than the first period, omitting transmission and reception during the plurality of checks, and performing transmission and reception for a last check with the device environment.

Accordingly, the program can obtain effects similar to those of the Technique 9.

The functions of the various embodiments described above can also be implemented by processing of supplying programs and applications for implementing the functions of the various embodiments described above to a system or device using a network, a storage medium, or the like, and having one or more processors in a computer of that system or device read and execute the programs.

In addition, the functions of the various embodiments described above may be achieved by a circuit that implements one or more functions (for example, an application specific integrated circuit (hereinafter referred to as “ASIC”) or a field programmable gate array (hereinafter referred to as “FPGA”)).

Although the various embodiments according to the present disclosure have been described above with reference to the drawings, it is needless to say that the present disclosure is not limited to such examples. It is apparent to those skilled in the art that various changes, corrections, substitutions, additions, deletions, and equivalents can be conceived within the scope of the claims, and it should be understood that such changes, corrections, substitutions, additions, deletions, and equivalents also fall within the technical scope of the present disclosure. In addition, components in the embodiments described above may be combined freely in a range without departing from the spirit of the invention.

### INDUSTRIAL APPLICABILITY

The present disclosure is useful as a development environment device, a device

control method, and a program.

What is claimed is:

1. A development environment device connected via a predetermined communication network to a device environment that includes a target device having a tuner, the development environment device comprising:
a memory in which a program is stored; and
a processor coupled to the memory and configured to perform processing by executing the program, the processing including:
determining whether a first waiting period is equal to or longer than a predetermined first period, the first waiting period being a period from transmission of a change instruction for a reception frequency of the tuner to the device environment until reception of a change completion response to the change instruction from the device environment,
when the first waiting period is shorter than the first period, sequentially performing transmission and reception with the device environment for a plurality of checks performed when the reception frequency of the tuner is changed, and
when the first waiting period is equal to or longer than the first period, omitting transmission and reception during the plurality of checks, and performing transmission and reception with the device environment for a last check.

2. The development environment device according to claim 1,
the processing further including:
when the first waiting period is shorter than the first period, sequentially performing a received signal strength indicator check, an orthogonal frequency division multiplexing synchronization check, a fast information channel quality check for a digital audio broadcast, and a main service channel quality check for the digital audio broadcast as the plurality of checks, and
when the first waiting period is equal to or longer than the first period, performing the main service channel quality check as the last check.

3. The development environment device according to claim 2,
the processing further including:
when it is determined that a result of the main service channel quality check is acceptable, setting a reception frequency of the target device to the reception frequency obtained by the change instruction.

4. The development environment device according to claim 1,
the processing further including:
when a waiting period from transmission of an instruction to the target device until a response to the instruction from the target device is equal to or longer than a predetermined period, extending a transmission interval at which instructions are transmitted to the target device from a next time onward to a predetermined transmission interval that is longer than the current transmission interval.

5. The development environment device according to claim 2,
the processing further including:
when a waiting period from transmission of an instruction to the target device until a response to the instruction from the target device is equal to or longer than a predetermined period, extending a transmission interval at which instructions are transmitted to the target device from a next time onward to a predetermined transmission interval that is longer than the current transmission interval.

6. The development environment device according to claim 3,
the processing further including:
when a waiting period from transmission of an instruction to the target device until a response to the instruction from the target device is equal to or longer than a predetermined period, extending a transmission interval at which instructions are transmitted to the target device from a next time onward to a predetermined transmission interval that is longer than the current transmission interval.

7. The development environment device according to claim 1,
wherein the target device is provided in a physical environment, and
wherein the development environment device is provided in a virtual environment.

8. The development environment device according to claim 2,
wherein the target device is provided in a physical environment, and
wherein the development environment device is provided in a virtual environment.

9. The development environment device according to claim 3,
wherein the target device is provided in a physical environment, and
wherein the development environment device is provided in a virtual environment.

10. A device control method to be executed by a development environment device connected via a predetermined communication network to a device environment that includes a target device having a tuner, the device control method comprising:
determining whether a first waiting period is equal to or longer than a predetermined first period, the first waiting period being a period from transmission of a change instruction for a reception frequency of the tuner to the device environment until reception of a change completion response to the change instruction from the device environment;
when the first waiting period is shorter than the first period, sequentially performing transmission and reception with the device environment for a plurality of checks performed when the reception frequency of the tuner is changed; and
when the first waiting period is equal to or longer than the first period, omitting transmission and reception during the plurality of checks, and performing transmission and reception with the device environment for a last check.

11. The device control method according to claim 10 further comprising:
when the first waiting period is shorter than the first period, sequentially performing a received signal strength indicator check, an orthogonal frequency division multiplexing synchronization check, a fast information channel quality check for a digital audio broadcast, and a main service channel quality check for the digital audio broadcast as the plurality of checks; and
when the first waiting period is equal to or longer than the first period, performing the main service channel quality check as the last check.

12. A non-transitory computer-readable storage medium having a computer program stored thereon and readable by a computer of a development environment device, the development environment device being connected via a predetermined communication network to a device environment that includes a target device having a tuner, the computer program, when executed by the computer, causing the development environment device to perform:
determining whether a first waiting period is equal to or longer than a predetermined first period, the first waiting period being a period from transmission of a change instruction for a reception frequency of the tuner to the device environment until reception of a change completion response to the change instruction from the device environment;
when the first waiting period is shorter than the first period, sequentially performing transmission and reception with the device environment for a plurality of checks performed when the reception frequency of the tuner is changed; and
when the first waiting period is equal to or longer than the first period, omitting transmission and reception during the plurality of checks, and performing transmission and reception with the device environment for a last check.

13. The non-transitory computer-readable storage medium according to claim 12,
wherein the computer program, when executed by the computer, further causes the development environment device to perform:
when the first waiting period is shorter than the first period, sequentially performing a received signal strength indicator check, an orthogonal frequency division multiplexing synchronization check, a fast information channel quality check for a digital audio broadcast, and a main service channel quality check for the digital audio broadcast as the plurality of checks; and
when the first waiting period is equal to or longer than the first period, performing the main service channel quality check as the last check.
